(19) United States
(12) Patent Application Publication
(10) Pub. No.: US 2015/0295287 A1
(43) Pub. Date: Oct. 15, 2015

(54) TEMPERATURE CONTROL DEVICE FOR AN ELECTRICAL ENERGY SUPPLY UNIT

(71) Applicant: Mahle Behr GmbH & Co. KG, Stuttgart (DE)

(72) Inventors: Alexandra Schnaars, Marbach (DE); Michael Moser, Ellwangen (DE); Dominique Raible, Rottenburg (DE)

(21) Appl. No.: 14/682,084

(22) Filed: Apr. 8, 2015

(30) Foreign Application Priority Data
Apr. 9, 2014 (DE) 102014206861.4

(51) Int. Cl. H01M 10/657; H01M 10/625; H01M 10/0525

(52) U.S. Cl. CPC H01M 10/657; H01M 10/0525; H01M 10/625; H01M 2220/20

(57) ABSTRACT

A temperature control device for an electrical energy supply unit may include a first delimiting element that may have at least a first layer composed of a fibre composite plastic. A second delimiting element may include at least a second layer composed of a fibre composite plastic. The second delimiting element may be mounted on the first delimiting element such that the first delimiting element and the second delimiting element may define a fluid duct for a fluid flow.

### CROSS-REFERENCE TO RELATED APPLICATIONS

This application claims priority to German Patent Application No. 10 2014 206 861.4, filed Apr. 9, 2014, the contents of which are hereby incorporated by reference in their entirety.

### TECHNICAL FIELD

The invention relates to a temperature control device for an electrical energy supply unit and a temperature control arrangement with a temperature control device. The invention furthermore relates to a temperature control arrangement with such a temperature control device. The invention further relates to a motor vehicle with such a temperature control arrangement.

### BACKGROUND

Rechargeable battery systems for electric vehicles with a purely electric drive and for hybrid vehicles and vehicles with fuel cell drive are the subject of current research. At present, in the named types of vehicle, lithium-ion batteries are preferably used, which are distinguished by a high energy density and an only weakly distinct memory effect. The capability of a rechargeable battery to supply various electric consumers installed in motor vehicles reliably with electrical energy depends to a considerable extent on the thermal conditions prevailing in the environment of the battery. This is because both the electrochemical processes occurring in the battery in the providing and also in the receiving of electrical energy—in the sense of recharging—are dependent to a not insignificant extent on the operating temperature of the battery. Of significant importance for an undisturbed operation of said batteries—this applies not only to said lithium-ion-based batteries, but generally to any rechargeable battery systems—is the creation of thermally well-defined environmental conditions. This means directly with regard to the considerable temperature fluctuations occurring in a motor vehicle during normal operation, that these must be balanced out thermally by suitable temperature control devices coupled thermally with the battery, in order to be able to keep the environmental temperature of the battery and hence also the temperature of the battery itself within a predetermined temperature interval.

The term “temperature control device” is understood to mean here in the present context any device which is able to reduce the current temperature of the battery unit which is to be temperature-controlled—in this case the temperature control device follows the operating principle of a cooling device—or to increase it. In the latter case, the temperature device acts as a heating device.

Modern temperature control devices are often constructed in the form of heat exchangers which have cooling plates which are able to be flowed through by a coolant. The battery units which are to be cooled are mounted in a planar manner onto said cooling plates and are thereby thermally coupled with the coolant. In order to now realize not only a cooling function, but also a heating function, such heat exchangers are often also provided with electric heating elements, for instance in the manner of PTC heating components, which can be electrically operated and heated. By suitable mounting of the heating elements, for instance in the manner of a sandwich between battery units and cooling plates or, alternatively thereto, in recesses provided on the cooling plates, the thermal contact between the battery units and the heating elements necessary for heating the battery units can be produced. A heat exchanger with cooling tubes for cooling a battery, but without integrated heating function, is described for instance in DE 10 2011 079 091 A1.

However, in such temperature control devices with integrated electric heating elements it proves to be problematic that the electric heating elements are typically produced from an electrically conductive material such as e.g. a metal and consequently require an electrical insulation with respect to the battery units which are to be heated.

Against this background, DE 10 2011 084 002 A1 describes a thermal transfer device which is arranged between a battery and a temperature control plate and is constructed in a layered manner with at least two layers. One of the layers, the so-called thermal insulation layer, serves here for the setting of a thermal resistance between battery and temperature control plate, a further layer, on the other hand, serves as a so-called tolerance compensation layer, by means of which locally different thicknesses of the thermal insulation layer can be compensated.

Against this background, electrical insulations in the form of plastic films or coatings of silicone are known from the prior art. However, the application of such layers generally entails considerable production expenditure, which has the effect of increasing the cost of the manufacturing process of the temperature control devices.

### SUMMARY

It is therefore an object of the present invention to create an improved temperature control device for the temperature control of an electrical energy supply unit, in particular a rechargeable battery.

The said object is solved by the subject of the independent claims. Preferred embodiments are the subject of the dependent claims.

The basic idea of the invention is accordingly to produce from a fibre composite plastic a temperature control device which is able to be flowed through by a coolant or heating medium. Such a fibre composite plastic—also known in specialist circles in the field of materials science as fibre plastic composite (FPC) or fibre-reinforced plastic—comprises reinforcement fibres which are embedded into a plastic matrix and are bonded to the plastic of the matrix by adhesive or cohesive forces. Such a combination of fibres and plastic matrix produces a layer material which has a high stability and, moreover, has the desired thermal and electrical characteristics—i.e. high thermal conductivity and electrical insulation. A fibre composite plastic is therefore excellently suited for the configuration of a fluid channel, in particular a fluid duct, for example in the manner of a fluid tube, for a fluid acting as heating medium or coolant. Such a fluid duct constitutes the central component of the temperature control device which is presented here. In addition, the plastic matrix presented here makes superfluous the additional provision of an electrical insulation, for instance in the form of an insulation layer of a plastic, as was mostly necessary hitherto in temperature control devices made of metallic fluid pipes, in order to insulate these electrically with respect to the metallic housing of the battery which is to be cooled, because such an electrical insulation is contained in the delimiting element in the temperature control device according to the invention.

A temperature control device according to the invention comprises a first delimiting element, which has at least a first layer of a fibre composite plastic. The temperature control device furthermore comprises a second delimiting element, which comprises at least a second layer of the fibre composite plastic and is mounted on the first delimiting element such that the two delimiting elements form a fluid duct for through-flowing by a fluid. It shall be understood that the said fluid duct can be composed not only of two delimiting elements, but also of a greater number of such delimiting elements. A delimiting element can, in turn, comprise several layers, as is to be discussed in further detail below.

An embodiment may be considered to be particularly advantageous, because it is simply constructed and therefore entails particularly low manufacturing costs, in which the first delimiting element consists of the first layer of the fibre composite plastic and the second delimiting element consists of the second layer of the fibre composite plastic. In other words, the two delimiting elements are formed respectively exclusively from the first or respectively second layer of the fibre composite plastic, i.e. no further layers are present.

Particularly expediently, the temperature control device can be constructed as a flat tube. In this way, the structural space required for the temperature control device can be kept relatively small. Furthermore, by means of such a plate-like construction, a planar and hence thermally highly effective contact can be produced with the component which is to be temperature-controlled, for example a battery which typically likewise comprises a housing part constructed in a plate-like manner. In a plate-like construction, connected therewith, of the delimiting elements, in a particularly preferred variant a matrix layer of a thermoplast can be provided respectively on the sides, facing one another, of the plate-like delimiting elements. This facilitates the shaping of the two delimiting elements and their fastening to one another.

A construction of the temperature control device which is mechanically stable and which is fluid-tight, necessary at the same time for the construction of the duct, can be achieved by the two delimiting elements being fastened to one another by means of their respective edge sections by means of a form-fitting or materially bonded connection. Form-fitting connections can be produced here by means of clipping, materially bonded connections by means of welding, in particular by means of hot gas welding, laser welding or friction welding.

In a particularly preferred embodiment, the fibres of the fibre composite plastic extend substantially along a shared direction of extent. This can be advantageous, if at least individual fibres—which will be explained in further detail below—are constructed so as to be electrically conductive and can be connected with an external energy supply unit, so that the functionality of a heating device is already integrated into said layer. Alternatively thereto, at least two, preferably even a plurality, particularly preferably even all fibres can extend along different directions of extent. Such an arrangement of the individual fibres is aimed at establishing the stability of the layer on loading under tension in an application-specific manner, and namely not only along a particular preferred direction, but rather independently of the direction of load.

Various material systems come into consideration as fibre material for the fibres embedded into the plastic matrix. The use of glass fibres, carbon fibres, aramid fibres and/or natural fibres is particularly recommended.

In order to now integrate the functionality of a heating device into the temperature control device which is presented here, it is proposed to use an electrically conductive material as fibre material for the fibres, so that at least one fibre of the fibre plastic composite is able to conduct electric current and/or heat. The already mentioned fibres of carbon come into consideration for this, but also metallic fibres, for instance of aluminium or copper. When the said electrically and/or thermally conductive fibres are connected on the end side via suitable electrical connections with an external electrical energy source or respectively with a suitable heat source, for instance a so-called electric auxiliary heater, the electric current flow or respectively the flow of heat through the fibres leads to a heating of the fibres, the plastic matrix and consequently also the entire first or respectively second layer of the temperature control device. In this case, the layer of the fibre composite plastic follows the operating principle of a heating device.

Alternatively or additionally, at least one of the fibres can be constructed in a thermally conductive manner, i.e. fibre materials with high thermal conductivity are selected, whereby the thermal coupling of the fluid flowing through the fluid duct to the component which is to be heated or cooled can be significantly improved.

Alternatively to the procedure, explained above, of implementing a heating function directly into the original fibres of the fibre plastic composite, an embodiment may also be considered to be advantageous in which the layer of the fibre plastic composite is additionally provided with an electric heating element for heating the temperature control device. Such a heating element can be formed for instance in the form of several heating wires or of at least one electrically conductive heating band, for example of a metal. In this case also the electric connection to an electrical energy source can take place via an end-side contacting of the heating wires or respectively heating bands. In a further alternative scenario to the previous one, an electrically conductive lacquer layer can also be applied on the layer of the fibre plastic composite, by means of which the desired heating function is brought about. Alternatively or additionally to the said heating bands/heating wires, one or more electric heating resistors, for instance in the manner of PTC elements, can be integrated into the fibre plastic composite.

In a particularly preferred embodiment, the heating wires and/or the at least one electrically conductive heating band can be constructed as an electric heating coil, such that an electric heating current is able to be induced in them by means of electromagnetic induction. In this way, a heating current can be generated in the heating wires or respectively in the heating band, i.e. no external electric connection elements are necessary.

In another preferred embodiment, an electrically conductive lacquer layer can also be applied on the layer of the fibre plastic composite, by means of which lacquer layer the desired heating function is brought about.

Of course, the temperature control device which is presented here can be expanded in the scope of structural configuration to forms of realization with two or more layers, which are then arranged on one another in the sense of a multi-layered structure. Each layer can be provided here with an individual functionality; for instance, it is conceivable to equip one layer in a completely electrically insulating manner with non-conductive fibres such as glass fibres or natural fibres and to arrange thereon a further layer which—as explained above—is penetrated by electrically conductive heating wires. Therefore, a variety of possibilities open up for the relevant specialist in the art for adapting the temperature control device according to the invention to different requirements.

If the first and/or second delimiting element, as discussed above, is composed of several individual layers which are layered on one another along a layer direction, the provision of a barrier layer is recommended. This can either be arranged between two adjacent layers, in order to ensure the diffusion tightness of the individual layers with respect to one another, or can be directed outwards as a so-called external barrier layer. Such a barrier layer can be realized for instance in the form of a composite film which in turn comprises a metal layer. Alternatively, a plastic film or a metal film is also conceivable, which has the desired characteristics with regard to the necessary tightness. By means of such a barrier layer, an undesired diffusion of the coolant or respectively heating medium through the delimiting elements can be effectively prevented.

Further layers possibly arranged on the layer of the fibre composite plastic, for instance the already presented barrier layer and/or the likewise already explained lacquer layer, can, since they can have different material characteristics in general and different coefficients of thermal expansion in particular, lead to a warping in the layer of the fibre composite plastic. In order to prevent this, it is recommended to provide a matrix layer of a thermoplast on both sides of a respective plate-like delimiting element. Warping effects possibly occurring on one side of the delimiting element are balanced out in this way and in an ideal case are completely compensated.

The invention furthermore relates to a temperature control arrangement with at least one energy supply unit, preferably a rechargeable battery, most preferably a lithium-ion battery. The energy supply unit is coupled here thermally with the previously presented temperature control device.

The invention further relates to a motor vehicle with at least one previously presented temperature control arrangement.

Further important features and advantages of the invention will emerge from the subclaims, from the drawings and from the associated figure description with the aid of the drawings.

It shall be understood that the features mentioned above and to be further explained below are able to be used not only in the respectively indicated combination, but also in other combinations or in isolation, without departing from the scope of the present invention.

Preferred example embodiments of the invention are illustrated in the drawings and are explained in further detail in the following description, wherein identical reference numbers refer to identical or similar or functionally identical components.

### BRIEF DESCRIPTION OF THE DRAWINGS

There are shown, respectively diagrammatically:

FIG. 1 an example of a temperature-control device according to the invention, in a longitudinal section,

FIGS. 2-5 variants of the example of FIG. 1.

### DETAILED DESCRIPTION

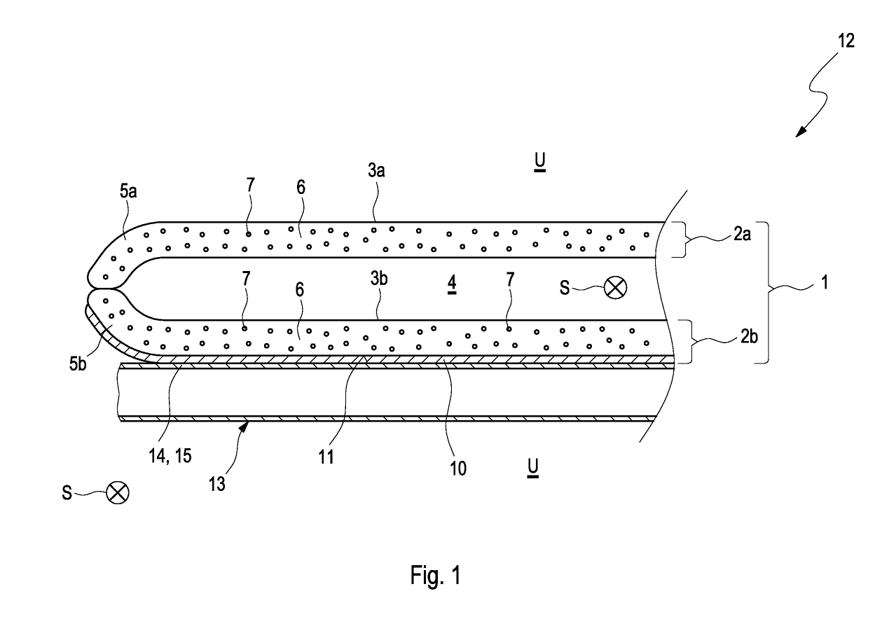

FIG. 1 illustrates an example of a temperature control device 1 according to the invention for an electrical energy supply unit in a longitudinal section. The temperature control device 1 comprises a first delimiting element 2a, which has at least a first layer 3a of a fibre composite plastic.

The fibre composite plastic comprises reinforcement fibres 7, which are embedded into a thermoplastic plastic matrix 6 and are bonded by adhesive or cohesive forces to the plastic of the matrix 6. The reinforcement fibres 7 are indicated only diagrammatically in the figures. The thermoplastic plastic matrix 6 renders superfluous the additional provision of an electrical insulation, for instance in the form of an insulation layer of a plastic, such as was mostly necessary hitherto in temperature control devices made of metallic fluid pipes, in order to insulate these electrically with respect to the metallic housing of the battery which is to be cooled, because such an electrical insulation is already integrated into the delimiting element 2a in the temperature control device 1 according to the invention. This is advantageous particularly when electrically conductive fibres are to be integrated into the matrix 6, as will be explained below in more detail.

In addition, the temperature control device 1 comprises at least a second delimiting element 2b, which in turn comprises at least second layer 3b of the fibre composite plastic. The two delimiting elements 2a, 2b are mounted on one another here such that they form a fluid duct 4 for flowing through by a fluid, in which they at least partially delimit this with respect to the environment U of the temperature control device 1. In other words, the delimiting elements 2a, 2b enclose the fluid duct 4 with respect to the environment U in a fluid-tight manner. In the example scenario of FIG. 1, a main through-flow direction S, along which the fluid, for instance a heating medium or coolant, flows through the fluid duct 3, runs orthogonally to the plane of the drawing. With respect to the said main through-flow direction S, each of the two delimiting elements 2a, 2b has a first and second edge section 5a, 5b extending along the main through-flow direction S. The two delimiting elements 2a, 2b are fastened to one another in the region of their edge sections 5a, 5b by means of a form-fitting connection—a clip connection is to be considered, for instance—or by means of a materially bonded connection such as for example friction welding or laser welding. For clarification, in FIG. 1 respectively only the first edge section 5a of the first delimiting element 2a and the first edge section 5b of the second delimiting element 2b is illustrated.

Different material systems can be selected for the fibres 7 embedded into the plastic matrix 6 of the first or respectively second layer 3a, 3b. For instance, glass fibres, carbon fibres, aramid fibres or natural fibres and a combination of two or more types of fibre come into consideration.

It is of course familiar to the relevant specialist in the art that for delimiting the fluid duct in addition to the two delimiting elements 2a, 2b further supplementary delimiting elements, not illustrated explicitly in FIG. 1, can be used. The delimiting elements 2a, 2b can also be constructed in the manner of boundary walls.

In a variant not shown in the figures, the two delimiting elements 2a, 2b can also consist exclusively of the first or respectively second layer 3a, 3b of the fibre composite plastic, i.e. the delimiting elements 2a, 2b have no further components. Alternatively thereto, the delimiting elements 2a, 2b shown in FIG. 1 can, however, also be expanded in a variety of variants of the example by one or more additional layers, which can then be arranged on one another in a stack-like manner in the form of a multi-layered structure.

In the arrangement shown in FIG. 1, the temperature control device 1 is realized in the manner of a flat tube with delimiting elements 2a, 2b constructed in the manner of half shells. The structural configuration of the delimiting elements 2a, 2b in a half shell type of construction proves to be particularly advantageous, because for the complete delimitation of the fluid duct 4 only two components—the two delimiting elements 2a, 2b—are required. Moreover, the structural space necessary for the temperature control device 1 can be kept relatively small, which may prove to be advantageous in particular in the use in motor vehicles. Also, by means of the shell-like construction which is shown, or—more generally also with a plate-like construction of the delimiting elements 2a, 2b, a planar and hence thermally highly effective contact with the component which is to be temperature-controlled, for example a battery, can be produced. This is because the latter typically has a battery housing with housing elements which are likewise constructed in a plate-like manner.

In the shell-like construction of the delimiting elements 2a, 2b shown in the figures, a matrix layer of a thermoplast (not shown) can be provided on the sides of the plate-like delimiting elements 2a, 2b facing one another. This facilitates the fastening of the two delimiting elements 2a, 2b to one another, in particular by means of the named methods, i.e. friction welding or laser welding. The same applies to the case of a form-fitting connection such as the already mentioned clip connection.

The functionality of a heating device can be optionally integrated into the temperature control device 1, by an electrically conductive material being used as fibre material for the fibres 7. Once again, the already mentioned fibres 7 of carbon come into consideration for this, alternatively also, however, metallic fibres, for instance of aluminium or copper. When electrically conductive fibres 7 are connected on the end side via suitable electric connections (not shown) with an external electrical energy source, the electric current flow through the fibres 7 leads to a heating of the fibres 7, the plastic matrix 6 and consequently also the entire first or respectively second layer 3a, 3b of the delimiting elements 2a. In a variant, it is also conceivable to connect said fibres 7 not with an electrical energy source, but with a heat source. Such a heat source can be, for instance, an electric auxiliary heater.

The fibres 7 can also be constructed so as to be thermally highly conductive, whereby the thermal coupling of the fluid flowing through the fluid duct 4 to the component which is to be temperature-controlled can be considerably improved.

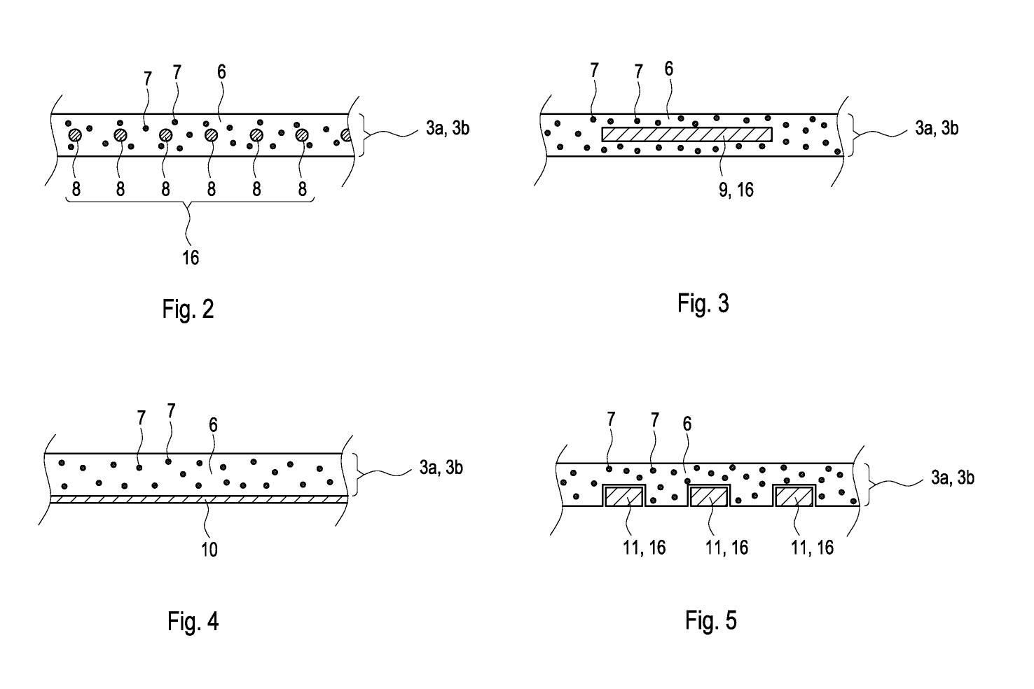

Alternatively to the previously explained procedure of implementing a heating function directly into the original fibres 7 of the fibre plastic composite, the first and/or second layer 3a, 3b of the fibre plastic composite can be additionally provided with an electric heating element 16 for heating the temperature control device 1. Such a heating element 16 can be realized for instance in the form of several heating wires 8 or at least one electrically conductive heating band 9, for example of a metal, which is shown diagrammatically in the illustration of FIG. 2 or respectively 3. In this scenario also the electric connection to an electrical energy source can take place via an end-side contacting of the heating wires 8 or respectively heating bands 9 (not shown). In another variant, said heating wires 8 or respectively the electrically conductive heating band 9 can be constructed as an electric coil, such that a heating current is able to be induced in them by means of electromagnetic induction. In this way, an electric heating current can be induced in the heating wires 8 or respectively in the heating band 9 wirelessly, i.e. without electric connection elements.

FIG. 4 illustrates a further variant of the temperature control device 1 with heating function integrated into the delimiting elements 2a, 2b, which can be combined without difficulty with the examples shown in FIGS. 1 to 3. According to this variant, an electrically conductive lacquer layer can be applied on the first and/or second layer 3a, 3b of the delimiting elements 2a, 2b, by means of which the desired heating function is brought about. Preferably, the lacquer layer 10 is applied here on a side of the first and/or second layer 3a, 3b hereon facing away from the fluid duct 4.

Finally, FIG. 5 illustrates a further variant for realizing a heating function, in which electric heating resistors 11, for instance in the manner of PTC elements, are integrated into the fibre plastic composite.

It is clear that the delimiting elements 2a, 2b of the temperature control device 1 presented here can be expanded within structural modifications to forms of realization with two or more layers, so that the delimiting elements 2a, 2b are formed having several layers. Each layer can then be provided with an individual functionality: for instance, it is conceivable to equip a layer in a completely electrically insulating manner with natural fibres, and to arrange on the latter a further layer, which—as shown in FIG. 2—is penetrated by electrically conductive heating wires 8. Therefore, a variety of possibilities open up for the specialist in the art for adapting the temperature control device 1 according to the invention to different requirements. By way of example, such a multi-layered structure is illustrated in FIG. 1, in which the second layer 3b of the second delimiting element 2b is coated on a side 11 facing away from the fluid duct 4 with the lacquer layer 10 shown in FIG. 4. The second layer 3b and the lacquer layer 10 therefore complement one another to the second delimiting element 3b.

When the first and/or second delimiting element 2a, 2b is composed, as explained above, of several individual layers which are layered on one another along a layer direction, the provision of a barrier layer between two adjacent layers is recommended, in order to ensure the diffusion tightness of the individual layers with respect to one another (not shown). Such a barrier layer can be realized for instance in the form of a composite film, which in turn comprises a metal layer. Alternatively, a plastic film is also conceivable, which has the desired characteristics with regard to the necessary tightness. By means of such a barrier layer, an undesired diffusion of the coolant or respectively heating medium through the delimiting elements is prevented.

In conclusion, looking again at FIG. 1, it can be seen that an energy supply unit 13, for example in the manner of a rechargeable battery, is thermally coupled to the temperature control device 1. The temperature control device 1 and the energy supply unit 13 form together a temperature control arrangement 12. In order to ensure a good thermal coupling of the energy supply unit 13 to the temperature control device 1, the energy supply unit 13 comprises a housing part 14 constructed as housing plate 15, which lies in a planar manner on the second delimiting element 2b of the temperature control device 1. When the fluid duct 4 of the temperature control device 1 is flowed through by a coolant, the waste heat generated by the energy supply unit 13 can be received by the coolant through thermal interaction with the coolant through the second delimiting element 2b. By means of the heatable lacquer layer 10, the energy supply unit 13 can be heated if necessary.

1. A temperature control device for an electrical energy supply unit, comprising:
a first delimiting element, which includes at least a first layer composed of a fibre composite plastic,
a second delimiting element, which includes at least a second layer composed of a fibre composite plastic, the second delimiting element being mounted on the first delimiting element such that the first delimiting element and the second delimiting element define a fluid duct for a fluid flow.

2. The temperature control device according to claim 1, wherein the first delimiting element consists of the first layer of the fibre composite plastic and the second delimiting element consists of the second layer of the fibre composite plastic.

3. The temperature control device according to claim 1, wherein at least one of:
the first delimiting elements and the second delimiting element are respectively configured in a plate-like manner, and
a matrix layer composed of a thermoplast is disposed on at least one side of the first delimiting element and the second delimiting element, respectively to define at least one of a form-fitting connection and a materially bonded connection, wherein the at least one side of the first delimiting element and the second delimiting element respectively at least one of faces towards one another and faces away from one another.

4. The temperature control device according to claim 1, wherein the first delimiting elements and the second delimiting element are secured to one another on a respective edge section via at least one of a form-fitting connection and a materially bonded connection.

5. The temperature control device according to claim 1, wherein at least one of the first delimiting element and the second delimiting element are configured with a shell-like geometry.

6. The temperature control device according to claim 1, wherein the fibre composite plastic of at least one of the first delimiting element and the second delimiting element includes at least one fibre, wherein the at least one fibre includes at least one of a glass fibre material, a carbon fibre material, a aramid fibre material and a natural fibre material.

7. The temperature control device according to claim 1, wherein the fibre composite plastic of at least one of the first delimiting element and the second delimiting element includes at least one fibre, wherein at least one of the at least one fibre is electrically conductive and includes at least two contact sections, the at least two contact sections being connectable with an electrical energy source, which in an electrically energized state operates as a heating device.

8. The temperature control device according to claim 1, wherein the fibre composite plastic of at least one of the first delimiting element and the second delimiting element includes at least one fibre, the at least one fibre being composed of a thermally conductive material.

9. The temperature control device according to claim 1, further comprising at least one electric heating element integrated into at least one of the first layer of the first delimiting element and the second layer of the second delimiting element.

10. The temperature control device according to claim 9, wherein the electric heating element includes at least one of a plurality of heating wires and at least one electrically conductive heating band.

11. The temperature control device according to claim 10, wherein the at least one of the plurality of heating wires and the at least one electrically conductive heating band are configured as an electric coil, the electric coil configured to be induced by an electric heating current via electromagnetic induction.

12. The temperature control device according to claim 9, wherein the electric heating element includes at least one heatable electric resistor.

13. The temperature control device according to claim 1, further comprising a lacquer layer of an electrically conductive lacquer disposed on at least one of the first layer of the first delimiting element and the second layer of the second delimiting element.

14. A temperature control arrangement, comprising:
at least one energy supply unit,
a temperature control device thermally coupled with the at least one energy supply unit and configured to control a temperature of the at least one energy supply unit, the temperature control device including:
a first delimiting element including a first layer composed of a fibre composite plastic; and
a second delimiting element positioned between the first delimiting element and the at least one energy supply unit, the second delimiting element including a second layer composed of a fibre composite plastic;
wherein the first delimiting element mounts the second delimiting element to define a fluid duct therebetween for communicating a fluid flow.

15. The temperature control arrangement according to claim 14, wherein the at least one energy supply unit includes a housing part, the housing part including a planar geometry and mounts a corresponding side of the second delimiting element of the temperature control device.

16. The temperature control arrangement according to claim 14, wherein the at least one energy supply unit and the temperature control device are incorporated into a motor vehicle.

17. The temperature control arrangement according to claim 14, wherein the fibre composite plastic of at least one of the first delimiting element and the second delimiting element includes a plurality of fibres, the plurality of fibres respectively being composed of at least one of a glass fibre material, a carbon fibre material, an aramid fibre material and a natural fibre material.

18. The temperature control arrangement according to claim 14, wherein the fibre composite plastic of at least one of the first delimiting element and the second delimiting element includes at least one fibre composed of a thermally conductive material.

19. The temperature control arrangement according to claim 14, further comprising at least one electric heating element integrated into at least one of the first layer of the first delimiting element and the second layer of the second delimiting element.

20. A temperature control device for an energy supply unit, comprising:
a first delimiting element including a first layer composed of a fibre composite plastic; and
a second delimiting element mounted to the first delimiting element at a contact point, the second delimiting element including a second layer composed of a fibre composite plastic, wherein the first delimiting element and the second delimiting element define a fluid duct therebetween for communicating a fluid flow;
wherein at least one of the first layer and the second layer includes at least one electric heating element, the electric heating element including at least one of a plurality of heating wires and at least one electrically conductive heating band.
